(19) United States
(12) Patent Application Publication
(10) Pub. No.: US 2017/0217557 A1
(43) Pub. Date: Aug. 3, 2017

(54) PLEATED FILTER, PLEATED FILTER CARTRIDGE, AND BALLAST WATER TREATMENT DEVICE AND BALLAST WATER TREATMENT METHOD, EACH USING SAME

(71) Applicant: SUMITOMO ELECTRIC INDUSTRIES, LTD., Osaka-shi, Osaka (JP)

(72) Inventors: Satoshi YAHAGI, Osaka (JP); Shinichi KANAZAWA, Osaka (JP); Munetsugu UEYAMA, Osaka (JP); Kazuhiro TANIDA, Osaka (JP)

(73) Assignee: SUMITOMO ELECTRIC INDUSTRIES, LTD., Osaka-shi, Osaka (JP)

(21) Appl. No.: 15/500,535

(22) PCT Filed: Aug. 28, 2015
(86) PCT No.: PCT/JP2015/074347

§ 371 Date: Jan. 31, 2017

(30) Foreign Application Priority Data
Sep. 4, 2014 (JP) 2014-180409

(51) Int. Cl. B63J 4/00; C02F 1/50; B01D 33/00; C02F 1/00; B01D 33/11; B01D 33/80

(52) U.S. Cl. CPC B63J 4/002; B01D 33/11; B01D 33/80; B01D 33/0093; C02F 1/001; C02F 1/50; C02F 2103/08

(57) ABSTRACT

A pleated filter includes a filter base having folds that repeatedly form mountains and valleys and having a cylindrical shape whose axial direction is a ridge line direction of the folds. The pleated filter includes, in a valley projecting to the inside of the cylindrical shape, a bonded reinforcing portion extending in the ridge line direction of the folds.

### TECHNICAL FIELD

The present invention relates to a structure of a pleated filter that is mainly used for filtration of a liquid. In particular, the present invention relates to a pleated filter used in a treatment system of ballast water stored in ships and used for filtration of a large amount of water, and a device using the pleated filter.

### BACKGROUND ART

A wide variety of filters are used for the purpose of separating and removing a solid, which is a contaminant, from a gas or a liquid. Pleated filters whose filtration areas are increased by folding a filter so as to have a pleated shape are also used mainly in applications involving a gas, for example, in an air purification system. Patent Literature 1 discloses an example of the use of a cylindrically shaped pleated filter as a filter device for removing sludge from a cutting fluid of a machine tool. Regarding this device, it is described that a filter device having a high cleaning effect of a filter can be provided by ejecting a liquid toward an outer surface of a cylindrical filter while rotating the filter.

In recent years, treatment of ballast water carried in ships has become an issue. Ballast water is seawater carried in a ship to provide safe voyage even when the ship is empty of cargo. Various methods for removing, killing, or inactivating microbes by purifying ballast water have been developed. Methods using filtration for the purpose of removing relatively large microbes have also been developed. For example, Patent Literature 2 describes a ballast water treatment device using a filter membrane, the device being filed by the applicant of the present invention.

### CITATION LIST

### Patent Literature

PTL 1: Japanese Unexamined Patent Application Publication No. 2008-93783

PTL 2: Japanese Patent No. 4835785

### SUMMARY OF INVENTION

### Technical Problem

In the case of seawater desalination, the use of brackish water/seawater for purposes such as ballast water, or the treatment of water such as sewage water, human sewage, or industrial wastewater, a preliminary filtration treatment for removing foreign matter, contaminants, and microbes in the water is necessary. The inventors of the present invention have been examining the application of a pleated filter to such filtration. In this case, it is necessary to filter a large amount of water in the shortest possible time. However, in general, the operation at a large scale/high flow rate causes a technical problem in that a decrease in the amount of treatment or the filtration function due to clogging at an early stage tends to occur.

The device disclosed in Patent Literature 2 is a filtering device in which a cylindrical filter is installed in a cylindrical housing and a liquid that is allowed to flow from the outside to the inside of the cylindrical filter is collected as a filtrate. A liquid to be filtered is ejected from a nozzle provided on a side face of the cylindrical housing onto a part of a filtering surface of the filter. Filtered products deposited on a surface of the filter are washed to recover the permeation flux, and the filtered products that have been washed out are discharged from a filtration front chamber. With this structure, a stable filtration state is continuously maintained. An important factor for stably maintaining continuous filtration of such a system is the cleaning effect obtained by ejecting the unfiltered liquid onto the filtering surface of the filter. In order to efficiently and effectively clean the entire filter by changing a cleaning region of the filter with time, the cylindrical filter is rotated during filtration by driving a motor or the like, thus continuously and periodically changing the position to which the ejection of the unfiltered liquid from the ejection nozzle is applied. In order to reliably perform this rotation cleaning and to stably maintain a high filtration flow rate, the ejection of the unfiltered liquid from the nozzle needs to be maintained at a certain high flow rate level or more. According to the studies conducted by the inventors, it was found that, as a result of being subjected to ejection of the unfiltered liquid at such a high flow rate, the cylindrical filter degrades with time and damage occurs, and part of the unfiltered liquid may be mixed directly with the filtrate without passing through the filter.

Accordingly, an object of the present invention is to provide a pleated filter whose degradation and damage due to use are prevented and which can be stably used for a long period of time, a ballast water treatment device functioning as a filtering device using the pleated filter, and a ballast water treatment method using the same.

### Solution to Problem

As a result of intensive studies on degradation of a filter, the inventors of the present invention confirmed a phenomenon in which damage tends to occur in folded portions corresponding to valleys of pleats of a filter that has been subjected to ejection of an unfiltered liquid at a high flow rate, and arrived at the following configurations.

Specifically, an embodiment of the present invention is a pleated filter including a filter base having folds that repeatedly form mountains and valleys and having a cylindrical shape whose axial direction is a ridge line direction of the folds, in which the pleated filter includes, in a valley projecting to the inside of the cylindrical shape, a bonded reinforcing portion extending in the ridge line direction of the folds.

Another embodiment of the present invention includes a ballast water treatment device including the pleated filter used as a filter membrane, a top surface of a cylinder and a bottom surface of the cylinder of the pleated filter each being sealed in a watertight manner, the pleated filter being rotatably held about a cylindrical axis; an untreated-water nozzle through which untreated water is ejected toward an outer circumferential surface of the pleated filter; a case that includes an outer cylindrical portion provided so as to surround the pleated filter and including a nozzle opening of the untreated-water nozzle therein; a filtered-water flow path that leads filtered water having passed through the pleated filter from the inside of the cylinder of the pleated filter to the outside of the case; and

a discharge flow path through which discharge water that is not filtered by the pleated filter is discharged to the outside of the case.

Still another embodiment of the present invention is a method for treating ballast water, the method including installing the ballast water treatment device in a hull; using, as untreated water, seawater taken from the outside of the hull; further applying a sterilization treatment to filtered water treated by the ballast water treatment device; and subsequently storing the resulting water in the hull as ballast water.

### Advantageous Effects of Invention

According to the above, it is possible to provide a pleated filter whose damage due to use is prevented, thereby contributing to stable use for a long period of time, and a ballast water treatment device and a ballast water treatment method using the pleated filter.

### BRIEF DESCRIPTION OF DRAWINGS

FIG. 1 is a perspective schematic view illustrating a typical structural example of a pleated filter.

FIG. 2 is an enlarged schematic view illustrating a part of the pleated filter in FIG. 1 and illustrating a structural example in which a part of a valley (portion V) is bonded.

FIG. 3 is a view illustrating a part of a pleated filter and is an enlarged schematic view illustrating an example the structure in which a reinforcing member is provided on a part of a valley (portion V).

FIG. 4 is a view illustrating a part of a pleated filter and is an enlarged schematic view illustrating an example the structure in which a reinforcing member is provided on a part of a valley (portion V).

FIG. 5 is a view illustrating a part of a pleated filter and is an enlarged schematic view illustrating an example the structure in which reinforcing members are provided on a part of a valley (portion V).

FIG. 6 is a view illustrating a part of a pleated filter and is an enlarged schematic view illustrating an example the structure in which a reinforcing member is provided on a part of a valley (portion V).

FIG. 7 illustrates an example of an embodiment in which reinforcing members are provided in valleys and is a view illustrating the overall structure of a pleated filter.

FIG. 8 is a view illustrating a basic structure of a pleated filter cartridge in which lid members are provided on and under the pleated filter in FIG. 7.

FIG. 9 is a view illustrating a part of a pleated filter and is an enlarged schematic view illustrating a structural example in which a reinforcing member is provided on a valley (portion V) and another reinforcing member is also provided inside a mountain (portion M).

FIG. 10 is an enlarged schematic view illustrating an example in which, in the structural example in FIG. 9, a mountain of a filter base is reinforced by being impregnated with a resin.

FIG. 11 is a view illustrating an example of a ballast water treatment device according to an embodiment of the present invention and is a sectional schematic view illustrating the structure of a vertical section including an axis line.

FIG. 12 is a schematic view illustrating the structure of a horizontal A-A section in FIG. 11.

FIG. 13 is a block diagram illustrating an example of the overall structure of a ballast water treatment system using a ballast water treatment device according to an embodiment of the present invention.

### REFERENCE SIGNS LIST

10, 101 pleated filter
11 filter base
21, 22, 23, 24 reinforcing member
12, 13 lid member
25 mountain-reinforcing member
14 resin
41 pump
42 filtering device
43 sterilization device
44 tank
31, 32, 33, 34, 35, 36 pipe
102 untreated-water nozzle
103 case
106 untreated-water flow path
107 filtered-water flow path
108 discharge flow path
121 nozzle opening
131 outer cylindrical portion
132 lid portion
133 bottom portion
140 central pipe
141 water intake hole
190 motor
B bonded portion
V valley
M mountain

### DESCRIPTION OF EMBODIMENTS

### Description of Embodiments of Present Invention

Embodiments of the present invention will now be listed and described.

An embodiment of the present invention is a pleated filter including a filter base having folds that repeatedly form mountains and valleys and having a cylindrical shape whose axial direction is a ridge line direction of the folds, in which the pleated filter includes, in a valley projecting to the inside of the cylindrical shape, a bonded reinforcing portion extending in the ridge line direction of the folds.

Specifically, the pleated filter has a structure in which a plurality of folds on the inner circumferential side of a cylindrical pleated filter each include a bonded reinforcing portion. The bonded reinforcing portion is a reinforcing structure for preventing damage of a fold of the filter base by bonding a portion near the fold along the ridge line. The presence of the bonded reinforcing portion reinforces the filter base against deflection in a direction in which the ridge line of a fold intersects with the ridge line and suppresses damage due to bending.

This structure is particularly effective when the structure is used in a filtering device having a structure in which untreated water is filtered from the outside to the inside of a cylindrical pleated filter, and the flow rate and the pressure of the untreated water locally change. The reason for this is as follows. A movement in directions in which a fold of the pleated filter opens up and closes is repeated by the change in the flow rate (pressure) of the untreated water. As a result, the fold is acutely bent, and damage easily occurs in the fold.

The bonded reinforcing portion preferably includes a reinforcing member provided separately from the filter base, and the reinforcing member and the filter base are preferably bonded to each other in the ridge line direction. As a result of the formation of a fold in which the reinforcing member and the filter base are integrated with each other, the fold has high rigidity against bending, is unlikely to deform, and is not easily broken. The material of the reinforcing member is not limited as long as such an effect is achieved. Preferably, the reinforcing member has rigidity against bending, is unlikely to bend, and has a restoring force (elastic force). The reinforcing member is preferably corrosion-resistant to untreated water.

The bonded reinforcing portion is a part formed by bonding portions of the filter base to each other or a part formed by integrating the filter base with the reinforcing member, and is a part of the pleated filter extending along the ridge line of a fold. The integration of the filter base and the reinforcing member can be most typically achieved by bonding between the filter base and the reinforcing member. For the bonding, a known bonding method, such as bonding with an adhesive, is used in accordance with an object to be bonded.

A plurality of specific means of the bonded reinforcing portion will be described. The bonded reinforcing portion may include a reinforcing member provided separately from the filter base, and the filter base may be bonded in the ridge line direction so as to surround the reinforcing member. When the bonded reinforcing portion surrounds the reinforcing member that is provided separately, the completed filter has no projection in appearance and thus is easily handled. The bonded reinforcing portion may be a thermally fusion-bonded portion of the filter base that forms the folds, the thermally fusion-bonded portion being formed without using a reinforcing member. Since this bonded reinforcing portion is formed without using a reinforcing member, reinforcement can be easily achieved. This structure is advantageous in terms of, for example, the ease of production and reduction in the cost. Since this bonded reinforcing portion is formed by thermal fusion bonding, integration can be realized without using an adhesive. This bonded reinforcing portion can reduce variations in the shape and strength of the bonded portion due to interposition of an adhesive. In addition, this bonded reinforcing portion is preferable from the viewpoint of the ease of the production and a reduction in the material cost.

The bonding is preferably a bonding by ultrasonic bonding. Ultrasonic bonding is a method in which ultrasonic waves are applied to an object to be bonded to accelerate heat generation and integration is achieved by the effect with ultrasonic vibration. Since a commercially available device can be used as a device for the ultrasonic bonding, a reliable bonded portion can be formed at a low cost.

Examples of preferred materials for the structures described above include the following. Specifically, the filter base may be a non-woven cloth formed of polyethylene terephthalate, and the reinforcing member may be a sheet-like body formed of any resin selected from the group consisting of polypropylene, polyethylene, polyamide, polyester, and polyvinyl chloride. These materials are suitable not only in terms of properties for reinforcement but also in terms of boding by ultrasonic bonding. Accordingly, in view of, for example, the ease of handling during production, a reduction in the weight, and the cost, a resin member having required strength is preferably used as the reinforcing member. Polypropylene is particularly preferable from the viewpoint of having a suitable strength and restoring force. Some metallic materials and nonmetallic materials such as glass-ceramics have a performance superior to that of resins in terms of strength. However, in the present embodiment, a restoring force for deformation is also required. Therefore, when a metal is used, it is necessary to use a spring material or to perform a quenching treatment. However, comprehensively considering a processing for forming a mesh-like structure and corrosiveness for seawater, the resin materials mentioned above are suitable.

Another embodiment of the present invention is a pleated filter cartridge including any one of the pleated filters described above, and lid members disposed on an upper bottom portion and a lower bottom portion of the pleated filter. In order to use a cylindrical pleated filter for filtration, it is necessary that an upper bottom portion and a lower bottom portion be sealed so that liquid leakage does not occur between the inside and the outside of the tube. Such a sealing structure may be formed in the filtering device. The sealing structure is preferably formed as a pleated filter cartridge obtained by fixing in advance a pleated filter to lid members integrated with the pleated filter. According to this structure, handling of the cartridge is easy during, for example, production and transportation. This structure is also easily handled in terms of installation in a device.

A mountain-reinforcing member whose top and bottom are fixed by the lid members is preferably disposed on a back side of a mountain viewed from the outside of a cylindrical shape of the pleated filter cartridge. It is important not only to reinforce the valleys but also to suppress damage of folds in the mountains. An effective means for suppressing the damage is the mountain-reinforcing member whose top and bottom are fixed by the lid members. Preferred materials of the mountain-reinforcing member are the same as those of the reinforcing member used in a valley. The mountain-reinforcing member is not limited thereto and may be a member or reinforcing means other than this. Alternatively, such other member and reinforcing means may be used in combination.

An example of the other mountain-reinforcing means used in combination is a structure in which a fold in the mountain further includes a resin-impregnated reinforcement extending in the ridge line direction. By reinforcing the fold of the filter base by impregnation with a resin in addition to the mountain-reinforcing member, a synergistic reinforcing effect is expected to be obtained.

The present invention further discloses a ballast water treatment device in which the cylindrical pleated filter is used as a filter membrane. Specifically, the ballast water treatment device according to the present invention includes the cylindrical pleated filter used as a filter membrane, a top surface of a cylinder and a bottom surface of the cylinder of the pleated filter each being sealed in a watertight manner, the pleated filter being rotatably held about a cylindrical axis; an untreated-water nozzle through which untreated water is ejected toward an outer circumferential surface of the pleated filter; a case that includes an outer cylindrical portion provided so as to surround the pleated filter and including a nozzle opening of the untreated-water nozzle therein; a filtered-water flow path that leads filtered water having passed through the pleated filter from the inside of the cylinder of the pleated filter to the outside of the case; and a discharge flow path through which discharge water that is not filtered by the pleated filter is discharged to the outside of the case.

In the device having the above structure, untreated water is ejected from the nozzle opening outside the cylinder of the cylindrical pleated filter toward an outer surface of the pleated filter, and thus the pressure of the untreated water concentrates at a part of pleats. Consequently, the pressure is applied in directions in which the pleats open up, and damage of the filter is more likely to occur in each of a valley and a mountain, as described above. In view of this, by employing the above damage-preventing structure with the bonded portion, it is possible to expect advantages such as the suppression of the occurrence of filtration defects, a long-term operation of the device due to extension of the lifetime of the pleated filter, and a reduction in the operation cost.

In this device, the top and the bottom of the pleated filter may be sealed with lid members. The pleated filter may be used in the form of a pleated filter cartridge in which the pleated filter and the lid members are integrated with each other in advance.

A method in which the pleated filter is used for filtration may be a method for treating ballast water according to the present invention, the method including installing the ballast water treatment device in a hull; using, as untreated water, seawater taken from the outside of the hull; further applying a sterilization treatment to filtered water treated by the ballast water treatment device; and subsequently storing the resulting water in the hull as ballast water.

By using the device or using the method, damage of a filter is reduced as compared with existing techniques, and the filter can be stably used for a long period of time without causing filtration defects. Consequently, the labor cost of maintenance and the cost of materials to be exchanged can be reduced, and the production of ballast water can be further facilitated.

### Details of Embodiments of Present Invention

Structures of a pleated filter and a ballast water treatment device according to embodiments of the present invention will now be described with reference to the drawings. The scope of the present invention is not limited to these embodiments but is defined by the claims described below. It is intended that the scope of the present invention includes the meaning of equivalents of the claims and all modifications within the scope of the claims.

### (Structure of Pleated Filter)

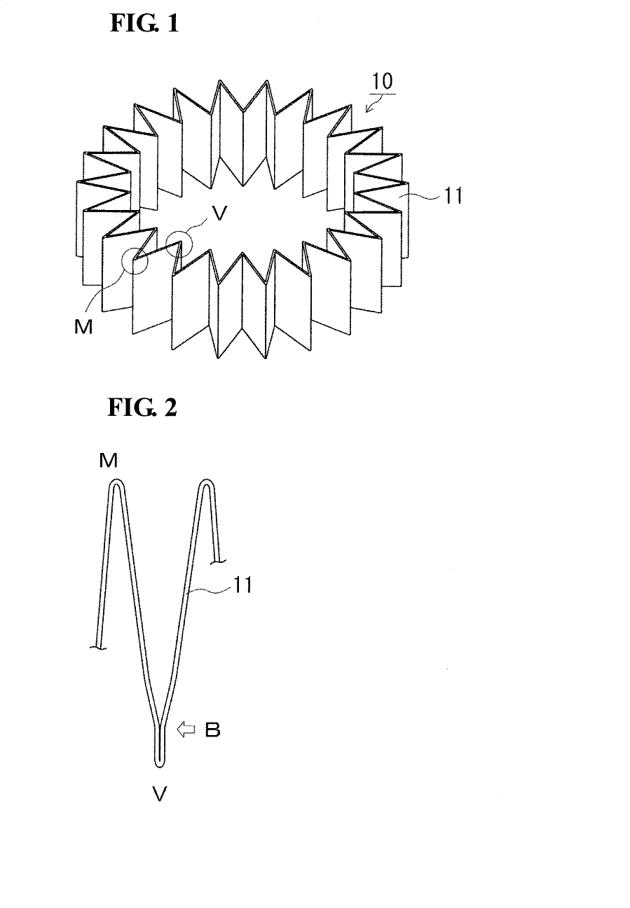

FIG. 1 is a perspective schematic view illustrating an example of a typical structure of a pleated filter. A pleated filter 10 in FIG. 1 is obtained by forming a pleated shape by repeatedly folding a sheet-like filter base 11 so as to have alternating mountains and valleys, and further connecting two ends of the filter base 11 to each other to have a cylindrical shape as a whole. In practical use, an upper surface and a lower surface of the cylinder of the pleated filter 10 are sealed with other members to fix the shape of the pleated filter 10. Filtration is performed from the inside to the outside of the cylindrical filter or, reversely, from the outside to the inside of the cylindrical filter. In the description of the present invention below, a portion V in the figure, the portion V being a fold projecting toward the inside of the cylinder, is referred to as a valley, and a portion M in the figure, the portion M being a fold projecting toward the outside of the cylinder, is referred to as a mountain. The term “outside of a valley” refers to a surface viewed from the inside of the cylinder in a valley. The term “inside of a valley” refers to a surface of a valley viewed from the outside of the cylinder. Note that FIG. 1 illustrates a pleated shape schematically. The actual folds do not form ideal acute angles as illustrated in the figure but often form rounded folds.

A porous resin sheet is used as the filter base. Examples of the filter base that can be used include porous structures such as a stretched porous body, a porous body by phase separation, and a non-woven cloth that are formed of a material such as polyester, nylon, polyethylene, polypropylene, polyurethane, polytetrafluoroethylene (PTFE), or polyvinylidene fluoride (PVdF). For the purpose of performing a treatment at a high flow rate, a non-woven cloth formed of a polyester such as polyethylene terephthalate is particularly suitably used.

It is assumed that untreated water is supplied from the outer circumferential side of the cylinder of the pleated filter 10 having the shape in FIG. 1 and filtered to the inside of the cylinder. In this case, the untreated water flows in a gap between pleats, and force is applied between pleats in directions in which the pleats open up. Since the top and the bottom of the pleats are fixed, as a result of expansion of central portions of the pleats, folds are bent in directions along the circumference. In addition, as a result of expansion of the gap between the mountains M, force is applied to a fold in a valley V in a direction in which the fold is pulled toward the outside of the cylinder. As a result of the repetition of such behaviors of folds in the mountains M and valleys V, damage occurs in the folds. In embodiments of the present invention, the term “reinforcement” mainly refers to suppression of damage caused in a part of a fold and means for suppressing the damage. The term “damage of a fold” refers to a defective portion that decreases the filtration performance, such as a splitting or through-hole, which is generated in a part of a fold due to repetitive behaviors applied to the fold.

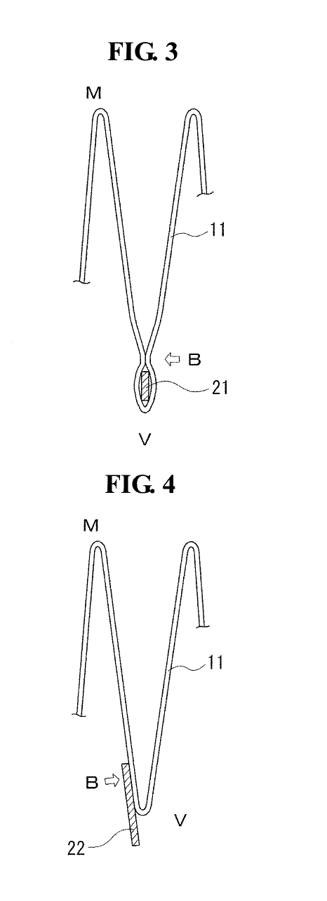

Embodiments of reinforcement of a valley will be sequentially described below. FIG. 2 illustrates an example of reinforcing means of a valley. FIG. 2 is a schematic view of only some of folds of the cylindrical pleated filter illustrated in FIG. 1 as an example, the view illustrating a section perpendicular to a cylindrical axis. In the figure, reference character M indicates a mountain, and reference character V indicates a valley. In a fold on the valley side of a filter base 11, the filter base 11 constituting the fold is bonded in a bonded portion B. Specifically, the filter base 11 is bonded in an axial direction of the cylinder at the position shown by B. The width of the bonded portion B (bonding width in a radial direction of the cylinder) is not limited as long as portions of the filter base are bonded to each other. With this reinforcing structure, when pleats move in directions in which the pleats open up and close, rigidity of the valley V increases with respect to force applied in the radial direction of the cylinder of the valley V, and damage due to extreme bending or concentration of bending can be prevented.

FIG. 3 is a view illustrating another example of reinforcing means of a valley. As in FIG. 2, FIG. 3 is a schematic view of only some of folds of the cylindrical pleated filter, the view illustrating a section perpendicular to a cylindrical axis. In the figure, reference character M indicates a mountain, and reference character V indicates a valley. In a fold on the valley side of a filter base 11, the filter base 11 constituting the fold is bonded in a bonded portion B. Specifically, the filter base 11 is bonded in an axial direction of the cylinder at the position shown by B. In this embodiment, a reinforcing member 21 is disposed between the fold and the bonded portion B so as to be surrounded by the filter base 11. The reinforcing member 21 is a member that extends in the axial direction of the cylinder along the fold of the filter. The reinforcing member 21 is preferably fixed by lid members of the pleated filter at upper and lower ends thereof. The width of the bonded portion B (bonding width in a radial direction of the cylinder) is not limited as long as portions of the filter base are bonded to each other so as to surround the reinforcing member 21 with a strength enough to prevent the portions of the filter base from being separated from each other in a use state. With this reinforcing structure, when pleats move in directions in which the pleats open up and close, rigidity of the valley V increases with respect to force applied in the radial direction of the cylinder of the valley V, and damage due to extreme bending or concentration of bending can be prevented.

The reinforcing member 21 in FIG. 3 is a sheet-like member having a rectangular section. However, the reinforcing member 21 is not limited thereto. For example, the reinforcing member 21 may be a columnar body such as a quadrangular column or a circular column. When the reinforcing member 21 is a member having corners, such as a sheet-like shape or a rectangular columnar shape, the corners are preferably rounded corners in order to suppress damage due to abrasion between the corners and the filter base.

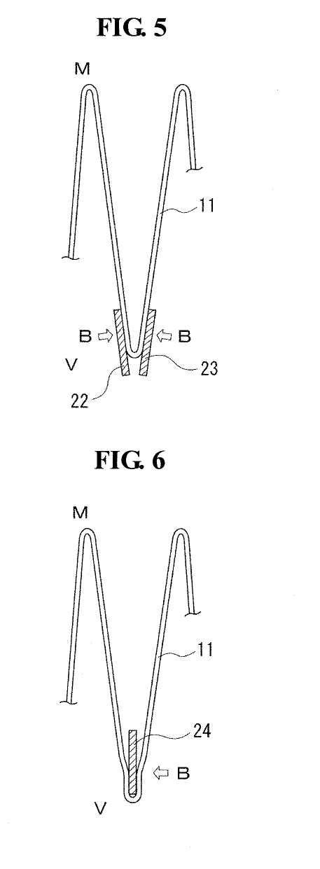

FIG. 4 is a view illustrating another example of reinforcing means of a valley. As in FIG. 2, FIG. 4 is a schematic view of only some of folds of the cylindrical pleated filter, the view illustrating a section perpendicular to a cylindrical axis. In the figure, reference character M indicates a mountain, and reference character V indicates a valley. In a fold on the valley side of a filter base 11, the filter base 11 constituting the fold and a reinforcing member 22 are bonded to each other in a bonded portion B. Specifically, the reinforcing member 22 is disposed so as to extend along a surface inside the cylinder of the filter base 11. The filter base 11 and the reinforcing member 22 are bonded to each other in the axial direction of the cylinder at the position shown by B. The reinforcing member 22 is a member that extends in the axial direction of the cylinder along the fold of the filter. The reinforcing member 22 is preferably fixed by lid members of the pleated filter at upper and lower ends thereof. The position of the bonded portion B is preferably close to a leading end of the fold but is not particularly limited as long as the position is located in a region in which the reinforcing effect can be obtained. The width of the bonded portion B (bonding width in a radial direction of the cylinder) is not limited as long as the reinforcing member 22 and the filter base 11 are bonded to each other in the bonded portion B with a strength enough to prevent the reinforcing member 22 and the filter base 11 from being separated from each other in a use state. With this reinforcing structure, when pleats move in directions in which the pleats open up and close, rigidity of the valley V increases with respect to force applied in the radial direction of the cylinder of the valley V, and damage due to extreme bending or concentration of bending can be prevented.

The reinforcing member 22 is preferably a sheet-like member. For example, a member that is a sheet as a whole and has a large number of holes penetrating the sheet, and a member that is a sheet as a whole and has a mesh-like structure can also be used as the reinforcing member 22. Such members are advantageous in a flow of a filtrate and a reduction in the weight of the whole.

FIG. 5 is a view illustrating another example of reinforcing means of a valley. The structure in FIG. 5 is similar to that in FIG. 4. The structure in FIG. 5 differs from the structure in FIG. 4 in that two reinforcing members are disposed on a single fold in a valley. In a fold on the valley side of a filter base 11, the filter base 11 constituting the fold is bonded to reinforcing members 22 and 23 in bonded portions B. The reinforcing effect can be increased by providing the reinforcing structure similar to that in FIG. 4 on two surfaces of the fold. On the other hand, from the viewpoint of increasing the filtration area of the whole pleated filter by densely arranging the valleys V, the reinforcement formed on only one surface is preferable, as illustrated in FIG. 4.

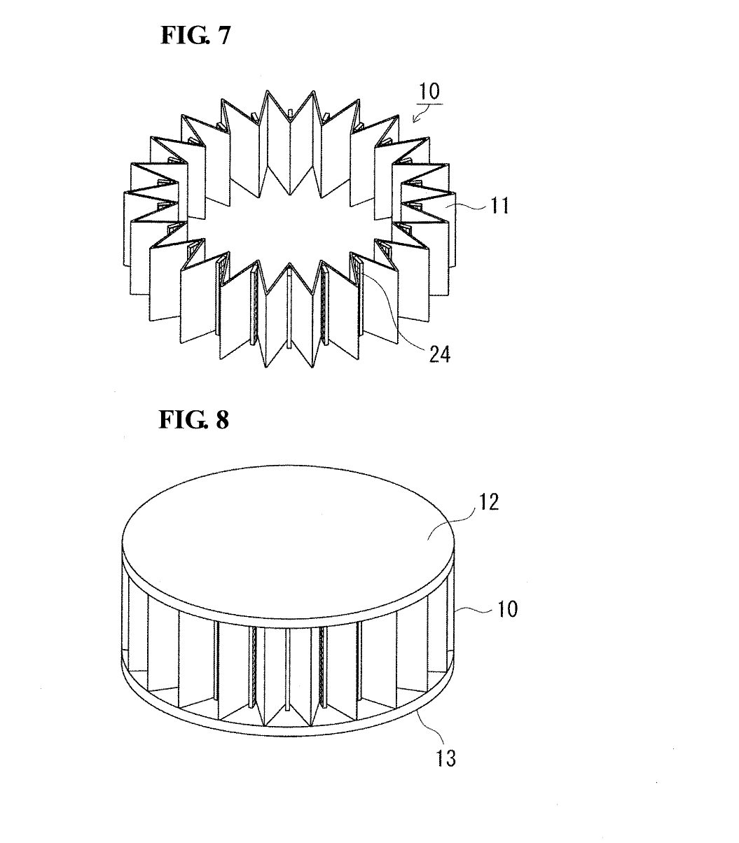

FIG. 6 is a view illustrating still another example of reinforcing means of a valley. The structure in FIG. 6 is similar to that in FIG. 3. A reinforcing member 24 is a sheet-like body, and the position of the bonded portion B is different from that in FIG. 3. In a fold on the valley side of a filter base 11, the sheet-like reinforcing member 24 is arranged inside the fold of the filter base 11 constituting the fold. In this embodiment, the reinforcing member 24 is bonded, in the bonded portion B, to the filter base 11 on each of a front surface and a back surface of the sheet. Specifically, the filter base 11 and the reinforcing member 24 are bonded to each other in the axial direction of the cylinder at the position shown by B. The reinforcing member 24 is a member that extends in the axial direction of the cylinder along the fold of the filter. The reinforcing member 24 is preferably fixed by lid members of the pleated filter at upper and lower ends thereof. The width of the bonded portion B (bonding width in a radial direction of the cylinder) is not limited as long as the filter base 11 and the reinforcing member 24 are bonded to each other in the bonded portion B with a strength enough to prevent the filter base 11 and the reinforcing member 24 from being separated from each other in a use state. With this reinforcing structure, when pleats move in directions in which the pleats open up and close, rigidity of the valley V increases with respect to force applied in the radial direction of the cylinder of the valley V, and damage due to extreme bending or concentration of bending can be prevented.

The reinforcing member 24 is a sheet-like member. For example, a member that is a sheet as a whole and has a large number of holes penetrating the sheet, and a member that is a sheet as a whole and has a mesh-like structure can also be used. Such members are advantageous in a flow of a filtrate and a reduction in the weight of the whole.

FIG. 7 is a perspective schematic view illustrating the whole of a pleated filter including bonded reinforcing portions disposed in a ridge line direction of folds and illustrates, as an example of an embodiment, the reinforcing structure illustrated in FIG. 6. FIG. 7 illustrates a state in which valleys V of pleats each have a reinforcing member 24 and the reinforcing member 24 is bonded to a filter base 11. The structure of the bonded reinforcing portions is not limited to the structure illustrated in the figure. The structure of the bonded reinforcing portions may be any of other structural examples described in the present application, any of structures as technical ideas encompassed by the scope of the disclosure of the present application, or any of structures equivalent to such structures.

The pleated filter is used in a state in which an upper bottom portion and a lower bottom portion of the cylinder are hermetically sealed so that the pleated filter is allowed to function as a filter for performing filtration through the inside and the outside of the cylinder. The hermetically sealed structure may be provided as a part of a filtering device used. The hermetically sealed structure may be integrally formed with the pleated filter. FIG. 8 is a perspective view illustrating a pleated filter cartridge in which lid members 12 and 13 are respectively disposed on an upper bottom portion and a lower bottom portion of a pleated filter to integrate with each other. The lid member 12 and the lid member 13 fix a filter base and reinforcing members of a pleated filter 10. The fixation can be achieved with a known adhesive or sealing material. The lid members preferably include guiding portions such as grooves or projections so as to facilitate the arrangement of pleats and reinforce the bonding. Although not shown in the figure, for example, a shaft for rotating the pleated filter and a through-hole for discharging a filtrate are provided in the lid members, as required. The form of a cartridge easily achieves reliable water-tightness of the pleated filter. Furthermore, the form of a cartridge facilitates handling such as transportation or exchange of the pleated filter.

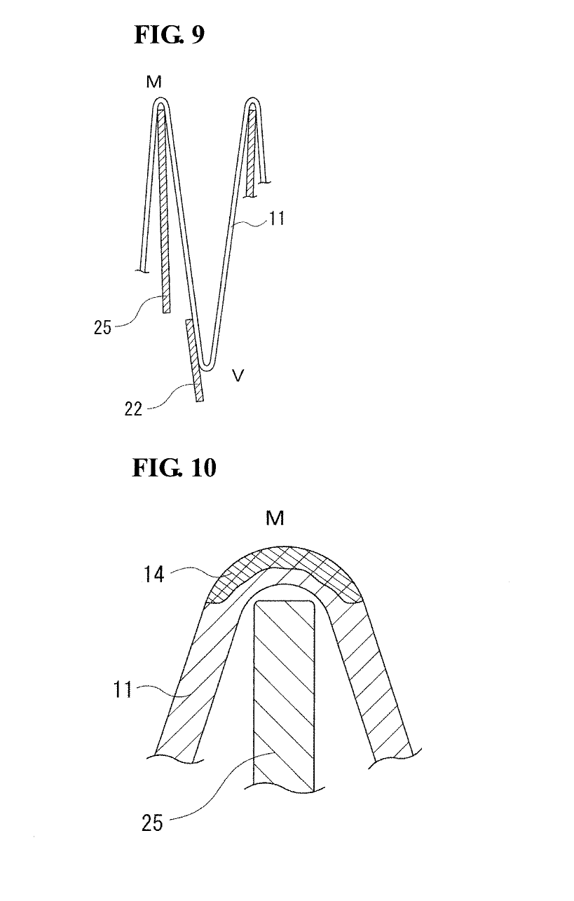

Structures that further include reinforcement of mountains M of a pleated filter will be described as other embodiments with reference to FIGS. 9 and 10. Note that reinforcing means of the mountains M may be means other than the reinforcing means described as examples below. FIG. 9 illustrates a structural example including a mountain-reinforcing member 25 inside a fold in a mountain M of a pleated filter. The mountain-reinforcing member 25 is a sheet-like member, and the top and the bottom of the mountain-reinforcing member 25 are fixed by lid members that are not illustrated in the figure. The mountain-reinforcing member 25 is provided for the main purpose of preventing the filter from being subjected to bending deformation in the circumferential direction of the filter. Specifically, while the mountain-reinforcing member 25 prevents a fold of pleats from bending at an obtuse angle (“dogleg” shape) in the circumferential direction, the mountain-reinforcing member 25 is preferably bent into a gentle curve and preferably has a restoring force for returning to the original shape when released from the pressure.

An example of a member that is preferably used as the mountain-reinforcing member 25 is a resin mesh-like sheet. Even when the mountain-reinforcing member 25 is formed of a simple sheet material, the reinforcing effect is obtained. However, the mountain-reinforcing member 25 preferably has a large number of holes penetrating from one surface of a sheet-like body to the other surface thereof. This is because the mountain-reinforcing member 25 having this structure is unlikely to disturb a flow of a filtrate. Examples of the mountain-reinforcing member 25 that can be used include, in addition to mesh-like sheet materials, punched materials obtained by forming a large number of holes in sheet materials, and sheet materials having continuous pores with a three-dimensional mesh-like structure. The material of the mountain-reinforcing member 25 is the same as that of a reinforcing member used in a valley V. A porous sheet formed of polypropylene is particularly preferable from the viewpoint of having suitable strength and restoring force.

In FIG. 9, a length of the mountain-reinforcing member 25 is preferably determined so as not to overlap with a reinforcing member 22 disposed on the valley side when pleats of the pleated filter are densely folded. This also applies to a case where the shape of the reinforcing member 22 on the valley side is different from that illustrated in FIG. 9 as an example. With the structure in which reinforcing members do not overlap with each other, pleats of the pleated filter can be arranged more densely to increase the filtration area.

FIG. 10 is a view illustrating another embodiment of reinforcement of a mountain. FIG. 10 is an enlarged schematic view illustrating an example in which, in the structural example in FIG. 9, a filter base 11 is reinforced by being impregnated with a resin in a fold in a mountain M. The impregnation with a resin 14 along the fold of the filter base 11 achieves further reinforcement for damage. FIG. 10 illustrates a reception-impregnated reinforcement in which the resin 14 is impregnated from a surface on the outside of a fold in a mountain of the filter base 11 to the inside of the filter base 11. However, this is merely a description of an example. The effect is also obtained in a resin-impregnated reinforcement in which the resin 14 completely permeates from a surface on the outside of a fold in a mountain of the filter base 11 to the opposite side (reinforcing sheet side) of the filter base 11. The effect is also obtained in a resin-impregnated reinforcement in which the resin 14 that is impregnated from a surface on the outside of a fold in a mountain of the filter base 11 to the opposite side (reinforcing sheet side) of the filter base 11 further adheres to the filter base 11 with a certain thickness so as to cover a surface of the filter base 11. Examples of the impregnating resin 14 that can be used include, but are not particularly limited to, thermosetting resins such as silicones, epoxy resins, and polyurethanes; thermoplastic resins such as polyesters, nylons, polyethylene, polypropylene, ETFE, and PVdF; and solutions prepared by diluting PVdF or a silicone with a solvent. Resins that easily adhere to the material of the filter are desirable. During impregnation, the impregnating resin 14 needs to have a fluidity for entering a porous body. On the other hand, after impregnation, it is necessary that the resin be integrated with a filter so as not to be easily separated from the filter. When the impregnating resin 14 is a thermosetting resin, the resin can be cured by heating after impregnation. When the impregnating resin 14 is a two-component curable resin, immediately after mixing, the mixed resin is impregnated and can then be cured. When the impregnating resin 14 is a resin that is diluted with a solvent to decrease the viscosity, after impregnation, curing is preferably performed after a while in order to give the solvent time to dry.

### (Filtering Device)

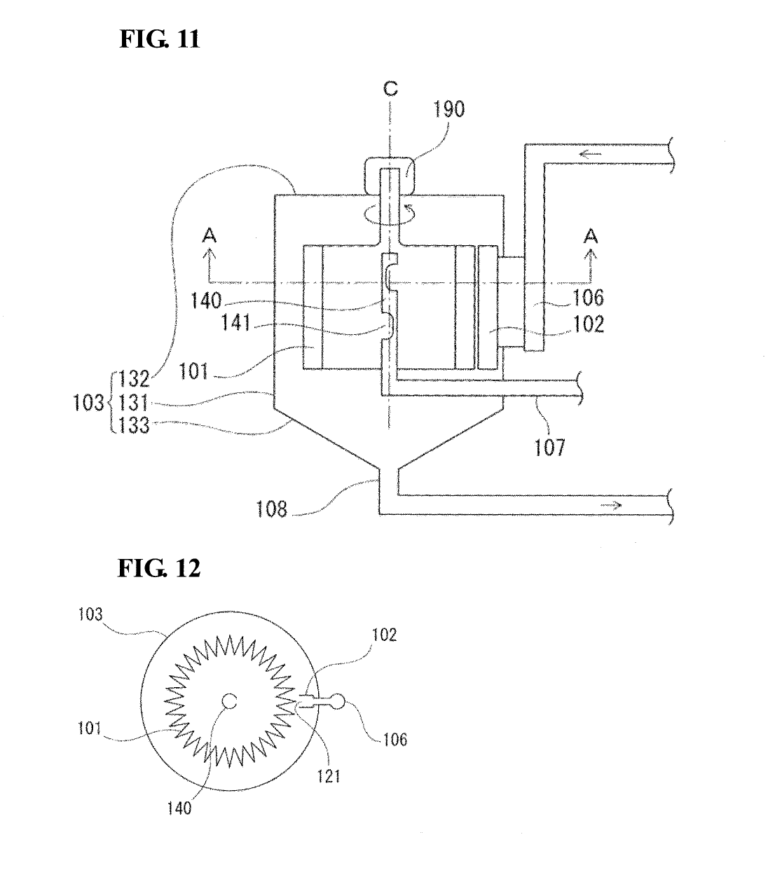

As a preferred application example of a filtering device using the pleated filter described above, a structure of a ballast water treatment device will be described with reference to drawings. FIGS. 11 and 12 are views illustrating an example of a device for treating ballast water for ships, according to an embodiment of the present invention. FIG. 11 is a schematic view illustrating the structure of a vertical section including an axis line. FIG. 12 is a schematic view illustrating the structure of a horizontal A-A section in FIG. 11. A cylindrical pleated filter 101 is disposed about an axis line, which is the center of rotation, and is mounted to be rotatable about a central pipe 140 arranged in the center (the pipe does not rotate). Upper and lower surfaces of the pleated filter 101 are sealed in a watertight manner. The pleated filter 101 may be used as a product in which the upper surface and the lower surface are sealed with lid members, that is, used as a pleated filter cartridge. The rotatable attachment structure also needs to have a watertight structure. However, the attachment structure is not particularly limited, and a known structure may be used. A case 103 is provided so as to cover the whole filter. The case 103 includes an outer cylindrical portion 131, a lid portion 132, and a bottom portion 133. A discharge flow path 108 is provided on the bottom portion 133. An untreated-water flow path 106 and an untreated-water nozzle 102 are provided in order to introduce seawater as untreated water into the case 103. The untreated-water nozzle 102 is provided to extend from the untreated-water flow path 106 so as to have a nozzle opening 121 thereof in the outer cylindrical portion 131 of the case 103, and is configured so that untreated water is ejected toward an outer circumferential surface of the pleated filter 101. A motor 190 is provided on the central axis of the pleated filter 101 for the purpose of the rotation of the pleated filter 101. The motor 190 is driven by an electric power supplied from a driving control unit (not illustrated).

In this embodiment, the untreated water ejected from the untreated-water nozzle 102 is applied to the outer circumferential surface of the pleated filter, and an effect of cleaning the pleated filter is obtained by the pressure of the untreated water. The untreated water that is not filtered and suspended substances settled in the case 103 are sequentially discharged from the discharge flow path 108 on the bottom portion 133 of the case 103. This point that filtration is performed while continuously and constantly discharging suspended substances and residual untreated water in this manner is also a feature of this device. This feature is advantageous for reliably achieving a large amount of treatment of 50 to 100 ton/hour and, in a larger system, 4,000 ton/hour, which are required for ballast water. In such a large-sized filtering device that treats a large amount of water, the size of the pleated filter is large, and thus it is particularly important to prevent the breakage of the pleated filter. Although valves and other components are not illustrated in the discharge flow path 108 in the figure, devices necessary for maintenance and flow rate control may be provided. The filtered water filtered by the pleated filter 101 is guided to a filtered-water flow path 107 through a water intake hole 141 provided in the central pipe 140 in the inside of the filter and is discharged to the outside of the case.

The nozzle opening 121 of the untreated-water nozzle 102 preferably has a rectangular opening. A large amount of untreated water is ejected from the untreated-water nozzle 102 into the outer circumferential surface of the pleated filter, thereby causing vibrations in directions in which folds of the pleated filter 101 open up and close. Thus, a hole such as a splitting easily opens in a fold. In this embodiment, a pleated filter including a reinforcing member is described as an example. Thus, damage can be effectively suppressed, and the device can be stably operated for a long period of time.

### (System for Treating Ballast Water for Ships)

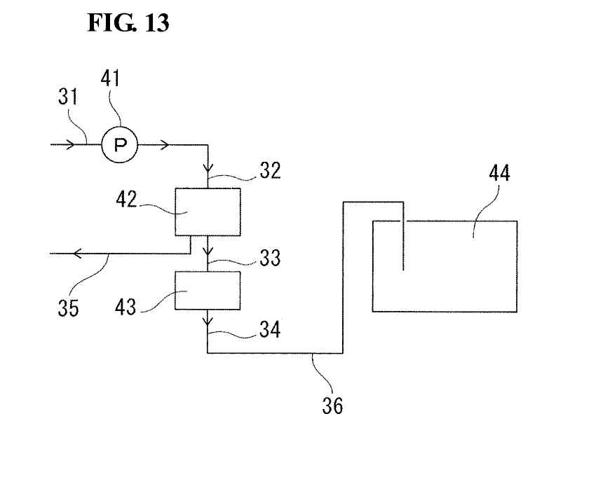

FIG. 13 is a diagram that schematically illustrates an overall structure of a system for treating ballast water for ships, in which the ballast water treatment device described above is used as a filtering device 42. In FIG. 13, untreated water, which is seawater taken from the ocean, is fed through a pipe 31 with a pump 41 and is supplied to the filtering device 42, which is filtering means, through a pipe 32. Filtered water filtered in the filtering device 42 passes through a pipe 33 and is fed to a sterilization device 43 (which is not essential) such as an ultraviolet irradiation device or an electrolytic device. Discharge water that has not been filtered in the filtering device 42 is led to the outside of the device through a pipe 35. The seawater that has been subjected to a sterilization treatment is fed to a tank 44 through pipes 34 and 36.

### EXPERIMENTAL EXAMPLES

(Selection of Reinforcing Member)

Resins used as a reinforcing member were selected as follows. The reinforcing member requires flexibility and rigidity with which the reinforcing member can be deformed so as to conform to deformation of a filter base, strength for repetitive deformation, and corrosion resistance. The reinforcing member also requires incidental requirements such as handling during production, a reduction in the weight, and a reduction in the cost. Furthermore, the reinforcing member preferably has adhesiveness or weldability with a filter base in order to form a bonded reinforcing portion. Table 1 shows the results when performance required for a material was examined by comparison from the above viewpoint.

Resin materials were examined as a reinforcing member in consideration of corrosion resistance and a reduction in the weight. The resin materials examined were polypropylene (PP), polyethylene (PE), polyvinyl chlorides (PVC), polyethylene terephthalate (PET), polytetrafluoroethylene (PTFE), an acrylonitrile-butadiene-styrene copolymer (ABS), and an ethylene-vinyl acetate copolymer (EVA). The comparison was performed using a high-density polyethylene (HDPE) as the polyethylene, and a flexible polyvinyl chloride and a rigid polyvinyl chloride as the polyvinyl chlorides. The items compared were tensile strength, breaking elongation, tensile modulus of elasticity, bending strength, impact strength, weldability, and resistance to acid/alkali. In Table 1, symbol “A” denotes an item in which the resin is determined to be preferably used as a reinforcing member, symbol “B” denotes an item in which the resin is determined to be applicable, symbol “C” denotes an item in which the resin is determined not to be applicable, and symbol “D” denotes an item in which application of the resin could not be determined. The PP and PE were determined to be preferable in all the items. Thus, it is believed that the PP and PE are particularly preferably used as a reinforcing member. The rigid polyvinyl chloride and PET are also applicable on the basis of comprehensive determination.

TABLE 1

| | | PE | PVC | PVC | | | | | |
|---|---|---|---|---|---|---|---|---|---|
| | PP | (HDPE) | (Rigid) | (Flexible) | PET | PTFE | ABS | EVA | Nylon |
| Tensile strength | A | A | A | B | A | A | A | B | A |
| Breaking | A | A | C | B | B | B | C | A | B |
| elongation | | | | | | | | | |
| Tensile modulus | A | A | A | D | A | B | A | C | A |
| of elasticity | | | | | | | | | |
| Bending | A | A | A | D | A | D | A | B | A |
| strength | | | | | | | | | |
| Impact strength | A | A | A | D | A | A | A | A | A |
| Weldability | A | A | A | A | B | C | A | D | B |
| (Adhesiveness) | | | | | | | | | |
| Resistance to | A | A | A | A | A | A | C | C | A |
| acid/alkali | | | | | | | | | |
| Comprehensive | A | A | B | D | B | C | C | C | B |
| evaluation | | | | | | | | | |

A: Preferable (Good)
B: Applicable (Acceptable)
C: Not applicable (Not acceptable)
D: No evaluation data (No data)

(Filtration Experiment)

In order to confirm the effect obtained by a reinforcing member, filtration was performed by using the ballast water treatment device illustrated in FIGS. 11 and 12. A pleated filter has an outer diameter (diameter of a circle having a circumference formed by mountains of a cylinder) of 700 mm, a length in the axial direction of 378 mm, a pleats depth of 70 mm, and a number of pleats of 450. Regarding operation conditions, a jet flow flux was 6.9 m/sec, a filtration flow rate was 71.7 m³/hour, and a discharge water flow rate of 14.3 m³/h. Materials described and used are as follows.

Filter base: Polyethylene terephthalate non-woven cloth (trade name: AXTAR™ G2260-1S BK0, manufactured by Toray Industries, Inc.)

Reinforcing member: Polypropylene sheet material, Nominal value of thickness: 1.0 mm
Folds in the mountains were reinforced by being impregnated with urethane (57 mm-width from a mountain defined as the center)

Mountain-reinforcing member: Polypropylene mesh sheet (trade name: TRICAL NET SN-598, manufactured by Takiron Co., Ltd.),
Mesh pitch: 4.8 mm×4.8 mm
Nominal value of thickness: 1.5 mm (warp 1.5 mm, weft 1.2 mm)

Pleats of the cylindrical pleated filter (having 450 pleats) were divided into six groups (each having 75 pleats) with every 60 degrees. Different reinforcing means were formed in the groups. The reinforcing means used are as follows. In each of the reinforcements, the mountain-reinforcing member and the urethane-impregnated reinforcement were provided as the reinforcement of each mountain. The mountain-reinforcing member has a width of 50 mm (70 mm in only reinforcing means 6) in a radial direction of the cylinder.
Reinforcing means 1: As a reinforcing member, a polypropylene sheet having a width of 20 mm was fusion-bonded to the filter base using ultrasonic waves so as to have the structure illustrated in FIG. 4.
Reinforcing means 2: Reinforcing means 2 was the same as the reinforcing means 1 except that the position at which the polypropylene sheet having a width of 20 mm was fusion-bonded using ultrasonic waves was located on the opposite of the reinforcing means 1 with respect to the right and left side. (The phrase “opposite with respect to the right and left side” refers to the following. When the section illustrated in FIG. 4 is assumed to be a section viewed from the top of the cylinder, in FIG. 4, the reinforcing member is provided on a surface of the left side of a valley V. On the other hand, the phrase “opposite with respect to the right and left side” refers to that the reinforcing member is provided on a surface of the right side of a valley V.)
Reinforcing means 3: As a reinforcing member, a polypropylene sheet having a width of 20 mm was fusion-bonded to the filter base using ultrasonic waves so as to have the structure illustrated in FIG. 6.
Reinforcing means 4: As a reinforcing member, a polypropylene sheet having a width of 3 mm was surrounded by the filter base, and the filter base was fusion-bonded using ultrasonic waves so as to have the structure illustrated in FIG. 3.
Reinforcing means 5: Portions of the filter base were fusion-bonded to each other using ultrasonic waves at a position 5 mm from a fold in a valley V so as to have the structure illustrated in FIG. 2.
Reinforcing means 6: Reinforcing means 6 was a comparative example and included no bonded reinforcing portion. However, valleys also included only the urethane-impregnated reinforcement as in mountains.

The bonding (thermal fusion bonding) by ultrasonic bonding in each of the reinforcing means is performed in the axial direction of the cylinder of the pleated filter. The bonding width in a direction perpendicular to the cylindrical axis is 2±0.6 mm. An ultrasonic plastic welder used was an ultrasonic welder 2000Xdt manufactured by Branson Ultrasonics, Emerson Japan, Ltd. Conditions are as follows.
Welding time: 600 msec
Holding time: 500 msec
Air pressure: 500 kPa
Trigger pressure: 500 N
Amplitude: 100%
Horn down speed: 60 mm/sec

A filtration operation was continued, and the presence or absence of damage of the filter was examined. After the operation was performed for 248 hours, in the reinforcing means 6 prepared as a comparative example, damage was confirmed in seven valleys. After 248 hours of the same operation, in the other reinforcing means 1 to 5, no damage was observed in any of the valleys, and thus the effects of the reinforcing means could be confirmed. The reinforcing means 1 and the reinforcing means 2 were particularly preferable. The position at which the reinforcing member was disposed is different between the reinforcing means 1 and the reinforcing means 2 with respect to the right and left side. Since the pleated filter performs filtration while rotating, the difference between the left side and the right side corresponds to a difference between the front and the back with respect to the rotation direction. According to the results of the filtration test, there was no significant difference between the reinforcing means 1 and the reinforcing means 2. Regarding the reinforcing means 3, the reinforcing effect is sufficiently observed. However, the reinforcing means 3 is slightly inferior to the reinforcing means 1 in that clogging in the valleys easily occurs. The reinforcing means 4 and the reinforcing means 5 are formed by thermal welding between portions of the filter base, and thus a portion of the filter base extending from the welded portion to a leading end of the fold cannot contribute to filtration. As a result, the filtration area slightly decreases.

In the above test, in each of the reinforcing means, the mountains were reinforced by the mountain-reinforcing members and impregnation with urethane. As a result, even when damage in the valleys was observed in the reinforcing means 6 prepared as a comparative example after the operation for 248 hours, no damage occurred in the mountains, and thus the effect of the reinforcement was confirmed. These results show that even when the reinforcement of a mountain is used alone, the reinforcement is effective means regardless of the presence or absence of the reinforcement of a valley. These results also show that more effective reinforcing effect is obtained by using the reinforcement of a mountain in combination with the reinforcement of a valley.

### INDUSTRIAL APPLICABILITY

According to the pleated filter of the present invention, a decrease in the performance due to damage does not occur, and the pleated filter has good durability. Accordingly, the pleated filter of the present invention can be suitable for use in preliminary filtration treatment for removing foreign matter, contaminants, and microbes in water in the cases of seawater desalination, the use of brackish water/seawater for purposes such as ballast water, or the treatment of water such as sewage water, human sewage, industrial waste water, or the like. Furthermore, the pleated filter of the present invention is suitable for the treatment of water having a high suspended substance/high SS (suspended solid) content and a concentration treatment, and thus can also be used in the field of collection of valuable recyclable materials, for example, in the field of food.

1. A pleated filter comprising a filter base having folds that repeatedly form mountains and valleys and having a cylindrical shape whose axial direction is a ridge line direction of the folds,
wherein the pleated filter includes, in a valley projecting to the inside of the cylindrical shape, a bonded reinforcing portion extending in the ridge line direction of the folds.

2. The pleated filter according to claim 1, wherein the bonded reinforcing portion is a thermally fusion-bonded portion of the filter base that forms the folds.

3. The pleated filter according to claim 1, wherein the bonded reinforcing portion includes a reinforcing member provided separately from the filter base, and the reinforcing member and the filter base are bonded to each other in the ridge line direction.

4. The pleated filter according to claim 1, wherein the bonded reinforcing portion includes a reinforcing member provided separately from the filter base, and the filter base is bonded in the ridge line direction so as to surround the reinforcing member.

5. The pleated filter according to claim 1, wherein the bonded reinforcing portion is bonded by ultrasonic bonding.

6. The pleated filter according to claim 3, wherein the filter base is a non-woven cloth formed of polyethylene terephthalate, and the reinforcing member is a sheet-like body formed of any resin selected from the group consisting of polypropylene, polyethylene, polyamide, polyester, and polyvinyl chloride.

7. A pleated filter cartridge comprising the pleated filter according to claim 1; and lid members disposed on an upper bottom portion and a lower bottom portion of the pleated filter.

8. The pleated filter cartridge according to claim 7, wherein a mountain-reinforcing member whose top and bottom are fixed by the lid members is disposed on a back side of a mountain viewed from the outside of a cylindrical shape of the pleated filter cartridge.

9. The pleated filter cartridge according to claim 8, wherein a fold in the mountain further includes a resin-impregnated reinforcement extending in the ridge line direction.

10. A ballast water treatment device comprising the cylindrical pleated filter according to claim 1, the pleated filter being used as a filter membrane,
a top surface of a cylinder and a bottom surface of the cylinder of the pleated filter each being sealed in a watertight manner, the pleated filter being rotatably held about a cylindrical axis;
an untreated-water nozzle through which untreated water is ejected toward an outer circumferential surface of the pleated filter;
a case that includes an outer cylindrical portion provided so as to surround the pleated filter and including a nozzle opening of the untreated-water nozzle therein;
a filtered-water flow path that leads filtered water having passed through the pleated filter from the inside of the cylinder of the pleated filter to the outside of the case; and
a discharge flow path through which discharge water that is not filtered by the pleated filter is discharged to the outside of the case.

11. A method for treating ballast water, the method comprising installing the ballast water treatment device according to claim 10 in a hull; using, as untreated water, seawater taken from the outside of the hull; further applying a sterilization treatment to filtered water treated by the ballast water treatment device; and subsequently storing the resulting water in the hull as ballast water.
